(19) United States
(12) Patent Application Publication
(10) Pub. No.: US 2016/0223103 A1
(43) Pub. Date: Aug. 4, 2016

(54) Pipe Dope Applicator Apparatus

(71) Applicant: Michael E. Osborne, Kirkland, WA (US)

(72) Inventor: Michael E. Osborne, Kirkland, WA (US)

(21) Appl. No.: 14/609,771

(22) Filed: Jan. 30, 2015

(51) Int. Cl. F16L 15/04; B05D 1/18; B05C 17/005

(52) U.S. Cl. CPC F16L 15/04; B05C 17/00569; B05D 1/18

(57) ABSTRACT

A method and apparatus for applying a liquid pipe dope to the threads of pipes including a metering cup for receiving the threads of a pipe in combination with a reciprocal pump that pumps the liquid pipe dope to the metering cup when the pipe is pushed into the metering cup; and then the pipe is further pushed downwardly to reciprocate the pump, causing flow of the liquid pipe dope to the threads via metering apertures.

### TECHNICAL FIELD

This invention relates generally to pipe thread applicator devices, and in particular to an improved applicator for applying a pipe dope sealing material to the threads of a pipe.

### BACKGROUND

Pipe dope, or pipe joint compound, is a gooey compound used to seal the connection between threaded pipes and fittings. Because the threads in pipes and fittings still leave an air gap between the two surfaces, the gap must be filled to make it water tight (or gas tight for gas lines).

Pipe dope has been around for a very long time and tends to be the favorite product for professional plumbers. Also, pipe dope should not be used on plastic threads, unless the container identifies it as safe for use on plastic pipe. Pipe dope is non-hardening and works as both a sealant and a lubricant. This is useful for unthreading pipes if the need arises and so gives it some advantage for that reason. However, because it is a lubricant, it can allow for over-tightening of plastic pipe which can lead to cracking and breakage. In practice, to apply pipe dope, the pipe dope is usually just applied as a coat onto the threads of a male thread set using the brush applicator supplied with the container in which the dope is sold. It is important to make sure all the threads are covered and avoid applying dope over the end or inside the pipe. If the pipe dope is not applied in the right amount and evenly, the joint may not be sealed properly when the male threads of the pipe are tightened into a female threaded fitting.

Improved pipe dope applicators, for example those shown in U.S. Pat. Nos. 5,743,667; 5,222,821; 4,932,801 (all to Osborne and all incorporated herein by reference in their entirety) and other various prior art methods and structures have been used to apply thread sealing liquids to pipes. Some of these pipe dope applicators are more effective or fool proof than others. Some are more effective yet are more costly to manufacture than others.

Accordingly, there is need for an economical, yet fool-proof, dope pipe applicator that is not subject to human error when it is used to apply pipe dope to the threads of the end of a pipe.

### BRIEF DESCRIPTION OF THE DRAWINGS

The above needs are at least partially met through provision of the method and apparatus described in the following detailed description, particularly when studied in conjunction with the drawings, wherein:

FIG. 1 is a perspective view of a pipe dope applicator connected to a typical receptacle/container in which such product is commercially sold except the original cap of the receptacle has been replaced by a preferred embodiment of the present invention;

FIG. 2 is a cross sectional view of the preferred embodiment of FIG. 1 and shown with a pipe having threads shown before the invention is being used to apply pipe thread dope to the threads; and

FIG. 3 is a cross sectional view, like FIG. 2, but showing the pipe in dashed lines having been pushed into the inner portion of a pipe dope metering cup and showing how the pipe dope is forced through the metering apertures to coat the threads of the pipe;

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

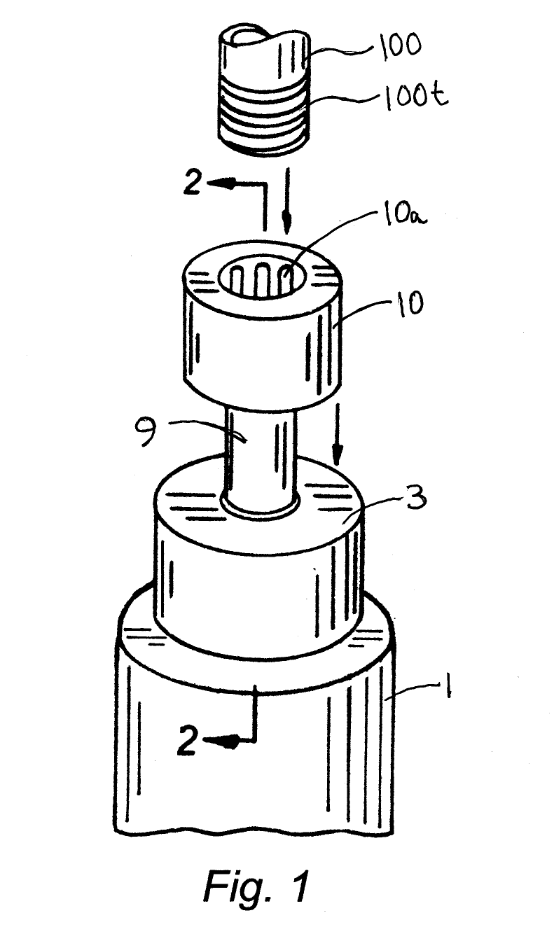

Referring now to the drawings, wherein like reference numerals indicate identical or similar parts throughout the several views, FIGS. 1-3 show a preferred embodiment of the present invention attached to a receptacle/container/can 1 of pipe dope that is commercially available. A threaded lid (not shown) of the receptacle 1, which has a brush attached thereto, is removed and discarded and all of the parts shown in FIGS. 1-3 are used on the can/container/receptacle 1, instead of the lid.

A manually activated reciprocal pump as shown in FIGS. 1-3 is like the one shown in U.S. Pat. No. 3,724,726 to Suzuki (incorporated herein by reference), but any suitable positive displacement pump could be used instead of the Suzuki pump, such as the reciprocal pump shown in U.S. Pat. Nos. 3,288,334 to Corsette, 3,414,169 to Corsette, or 4,607,765 to Ruscitti, for example (which patents are also incorporated herein by reference in their entirety).

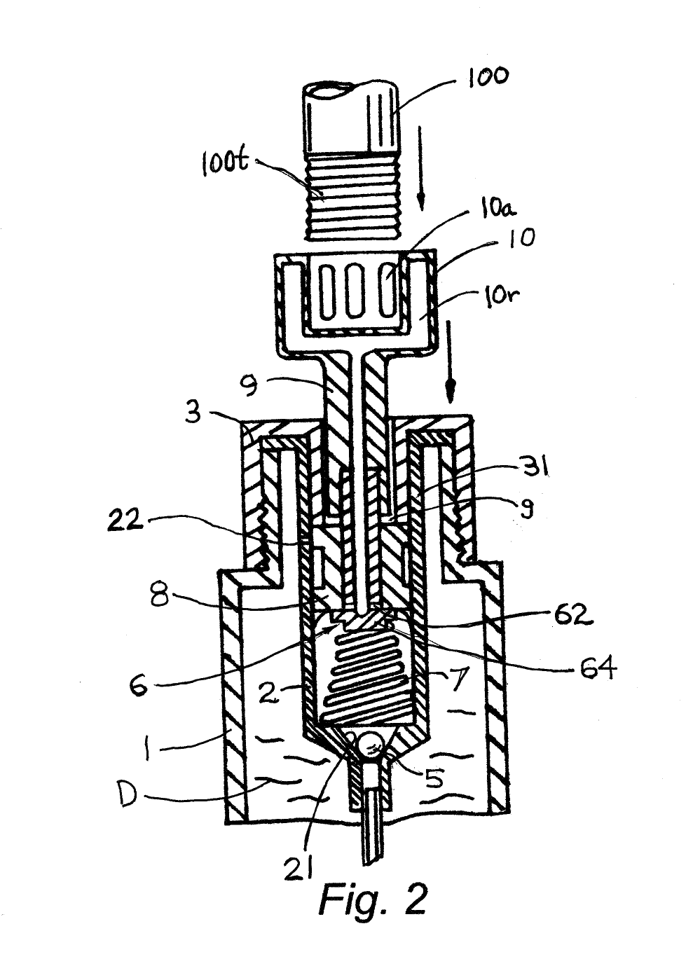

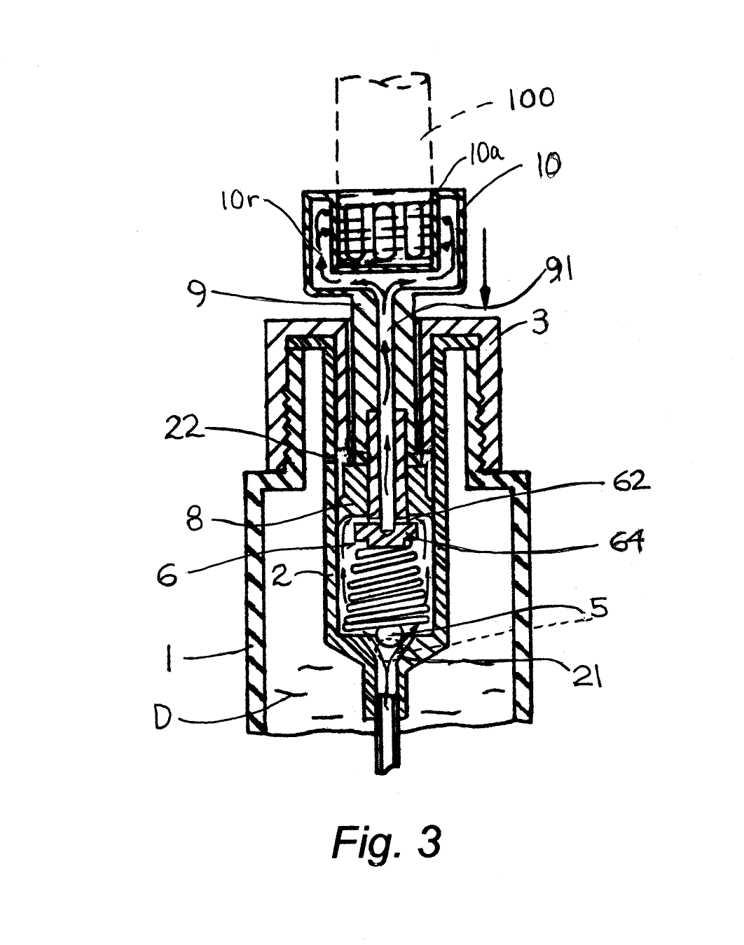

A cup 10 is provided for receiving the threaded end 100t of a pipe 100. When the pipe 100, shown in FIGS. 1 and 2 is pushed downwardly into the cup 10, that action causes the cup 10 and plunger 9 to be pushed downwardly from the position shown in FIGS. 1 and 2 to the position in FIG. 3. The movement of the plunger 9 and cup 10 from the FIGS. 1 and 2 positions to the FIG. 3 position causes the liquid pipe dope D in the can/container/receptacle 1, the part in chamber 2, to be pushed upwardly through openings 62 and 91 into the cup reservoir 10r and then be forced out the metering apertures 10a to evenly coat the threads 101t of the pipe 100. This causes exactly the same/right amount of pipe dope D to be applied to the threads each and every time that pipe threads 101t are inserted into the cup 10. So not only does it prevent the pipe thread dope D from being wasted, but it makes sure that enough pipe thread dope D is applied evenly to the threads 101t.

Describing the pump portion of FIGS. 2 and 3 in more detail, it is noted that the piston 8 is normally held in the first position shown in FIG. 2 by means of a coiled spring 7 whose lower end is seated upon the bottom of the cylinder 2 and whose upper end is normally pressed against the lower surface of the enlarged portion 64 of the valve rod 6. Therefore, under the force of the coiled spring 7, the enlarged portion 64 of the valve rod 6 is normally pressed against the undersurface of the piston 8 so that the passage 62 is maintained firmly closed. In turn the piston 8 is pressed against the lower end of the inner cylindrical wall 31 of the cap 3 so that the upward movement of the piston 8 is stopped or limited.

Looking now to FIG. 3, when the cup 10 is depressed by pushing down on the pipe 100 when the threads 100t are disposed in the cup 10, the plunger 9 is moved downwardly so that the valve rod 6 is also moved downwardly, thereby opening the hole or passage 62. Upon downward movement of the enlarged portion 64 of the valve rod 6, the pressure is exerted to the liquid within the cylinder 2 so that a part of the liquid is caused to rise through the axial opening 63. After the plunger 9 is moved downwardly a distance equal to the space g, the lower end of the plunger 9 contacts with the upper end of the piston 8 so that thereafter the piston 8 is caused to move downwardly, thereby immediately opening the suction port 22 and causing the one way valve ball 5 to seat to the dashed line position. Therefore, the surrounding atmosphere is introduced into the container 1 through the space C around the plunger 9 and the suction port 22 so that the discharge of liquid from the cylinder in response to the downward movement of the piston is further facilitated. The liquid is discharged out of the container 1 through the passages 63, 91, cup reservoir 10r and out through cup apertures 10a to coat the threads 100t of the pipe 100.

The metering cup can be made in a different size corresponding the diameter of other standard pipe sizes, or alternatively cylindrical adapters (not shown) with metering slots corresponding to and aligned with the metering slots 10a can be slid into the metering cup 10 to make the opening in the top of the cup 10 smaller as needed.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. A pipe dope applicator apparatus for coating a threaded end of a section of pipe with pipe dope contained in a receptacle with a threaded spout opening therein, wherein the apparatus comprises:
a threaded cap for threaded engagement with the threaded spout on the receptacle;
a central opening disposed in the threaded cap;
a reciprocal pump operatively attached to the threaded cap and being disposed in the central opening, the reciprocal pump including:
an inlet opening adjacent the bottom of the receptacle;
an outlet opening above the inlet opening;
a metering cup operatively attached to the pump, the metering pump comprising:
a recessed portion having an inner wall of a diameter size corresponding to a common diameter of pipe threads on a pipe, an outer wall disposed radially outwardly from the inner wall, the top of the inner and outer walls and the bottom of the inner and outer walls being sealed to thereby form an annular passageway chamber between the inner and outer walls, the recessed portion further having metering apertures in the inner wall and the passageway chamber also being in fluid communication with the outlet opening of the pump.

2. The apparatus as in claim 1 wherein the metering apertures of the cup member comprise a plurality of elongated spaced apart apertures.

3. A method of using a pipe dope applicator apparatus for coating a threaded end of a section of pipe with pipe dope contained in a receptacle with a threaded spout opening therein wherein the apparatus of a type comprising a threaded cap for threaded engagement with the threaded spout on the receptacle; a central opening disposed in the threaded cap; a reciprocal pump operatively attached to the threaded cap and being disposed in the central opening, the reciprocal pump including an inlet opening near the bottom of the receptacle and an outlet opening above the inlet opening; a metering cup operatively attached to the pump, the metering pump comprising a recessed cup having an inner wall of a diameter size corresponding to a common diameter of pipe threads on a pipe, an outer wall disposed radially outwardly from the inner wall, the top of the inner and outer walls being sealed and the bottom of the inner and outer walls being sealed to form an annular passageway chamber between the inner and outer walls, the recessed cup further having metering apertures in the inner wall and the passageway chamber also being in fluid communication with the outlet opening of the pump; said method comprising:
disposing a pipe with a threaded end above the metering cup;
pushing the threaded end of the pipe into the recessed portion of the metering cup; and
continuing to push downwardly on the pipe enough to activate the reciprocal pump to cause flow of liquid from the receptacle to coat the pipe threads via the metering apertures.
